(19) United States
(12) Patent Application Publication
(10) Pub. No.: US 2011/0024469 A1
(43) Pub. Date: Feb. 3, 2011

(54) MULTI-PURPOSE HITCH AND CARRIER ASSEMBLY FOR A GOLF CART OR THE LIKE

(76) Inventor: William B. KEY, Matthews, NC (US)

Correspondence Address: Clements Bernard PLLC, 1901 Roxborough Road, Suite 250, Charlotte, NC, 28211, US

(21) Appl. No.: 12/843,158

(22) Filed: Jul. 26, 2010

Related U.S. Application Data
(60) Provisional application No. 61/229,144, filed on Jul. 28, 2009.
(60) Provisional application No. 61/231,360, filed on Aug. 5, 2009.

(51) Int. Cl. B60R 9/00

(52) U.S. Cl. 224/274

(57) ABSTRACT

In one exemplary embodiment, the present invention provides a multi-purpose hitch and carrier assembly for a golf cart or the like including a top plate assembly adapted to be carried on a golf cart or the like. An extension arm is engaged to the top plate assembly for selectively securing an upright safety grab bar. At least one retention plate is configured to be selectively secured to the upright safety grab bar. A brace plate has at least two flanges that are engaged to the at least one retention plate by a retention means, and an engagement portion selectively coupled to the brace plate and configured to be selectively secured to a wheeled and handled utility trailer or the like.

### CROSS REFERENCE TO RELATED PATENT APPLICATION

The current application claims the benefit of the earlier priority filing date of the provisional application Ser. No. 61/229,144 that was filed on Jul. 28, 2009 and provisional application Ser. No. 61/231,360 that was filed on Aug. 5, 2009.

### FIELD OF THE INVENTION

The present invention relates generally to multi-purpose hitch and carrier assemblies for a golf cart, all-terrain vehicle, or the like. More specifically, the present invention relates to multi-purpose hitch and carrier assemblies that improve the load transporting capacity and efficiency of a golf cart, all-terrain vehicle, or the like.

### BACKGROUND OF THE INVENTION

Golf carts are currently used in a variety of communities and settings to conveniently and energy efficiently transport people and cargo over relatively short distances. Many such golf carts include rear facing auxiliary seating (typically for 2 additional people or a small amount of cargo). An upright safety grab bar is typically disposed adjacent to such auxiliary seating, at the rear-center of the golf cart. A variety of carrier assemblies have been designed and developed to attach to this upright safety grab bar (see, for example, US 2007/0023466-Policastro). Such carrier assemblies typically include upright brackets that slide over and engage the upright safety grab bar. This method of attachment, as well as the remainder of the carrier assemblies, are lacking and improved carrier assemblies are needed. Likewise, no suitable, vertically adjustable, multi-purpose carrier and hitch assembly exists for golf carts. Those that do are typically standard ball-socket or simple loop trailer hitch assemblies, limiting load transporting capacity and cargo carrying flexibility, making backing up difficult, etc. Thus, improved multi-purpose carrier and hitch assemblies are also needed. Ideally, the multi-purpose carrier assembly would also utilize the upright safety grab bar as their attachment point.

### BRIEF SUMMARY OF THE INVENTION

In one exemplary embodiment, the present invention provides a multi-purpose carrier assembly for a golf cart or the like includes an upright safety grab bar and at least one retention plate configured to be selectively secured to the upright safety grab bar. At least two flanges are engaged to the upright safety grab bar, and an engagement portion is selectively coupled to the at least two flanges and configured to be selectively secured to a wheeled and handled utility trailer or the like. In another embodiment, the multi-purpose carrier assembly includes two retention plates. The engagement portion includes a shank, a retaining strap having a first end and a second end, whereby the first end is engaged to the shank and the second end is selectively secured to the shank by a clip. The two retention plates include a pair of threaded bores that are configured to receive a correspondingly threaded screw for selectively securing the two retention plates to the upright safety grab bar. A bore is disposed within the at least two flanges for receiving a pin and selectively coupling the engagement portion to the brace plate. The brace plate may be engaged to at least one retention member for carry the at least two flanges. A basket with a lip may be disposed on the at least one retention plate for selectively securing the basket to the upright safety grab bar. It should be noted that, as used herein, the term “carrier” refers broadly to an adjustable accessory attachment device, as is illustrated, described, and claimed.

In another exemplary embodiment of the present invention, the multi-purpose hitch and carrier assembly for a golf cart or the like includes a top plate assembly, adapted to be carried on a golf cart or the like, and an extension arm engaged to the top plate assembly for selectively securing an upright safety grab bar. At least one retention plate is configured to be selectively secured to the upright safety grab bar, and a brace plate is engaged to the at least one retention plate and has at least two flanges that are engaged to the at least one retention plate by a retention means. An engagement portion is selectively coupled to the brace plate and configured to be selectively secured to a wheeled and handled trailer or the like. The extension arm may be hinged, resulting in a first portion and a second portion that moves from a first position to a second position, wherein the first position results in the second portion forming a 90 degree angle with respect to the second portion and a second position wherein the second portion is in a linear relationship with the first portion. The engagement portion includes a shank and a retaining strap having a first end and a second end, whereby the first end is engaged to the shank and the second end is selectively secured to the shank. The retaining strap is a resilient, ribbed gripping retaining strap.

In yet another exemplary embodiment of the present invention, a multi-purpose carrier assembly for a golf cart or the like includes an upright safety grab bar and two retention plates configured to be selectively secured to the upright safety grab bar. A brace plate having at least two flanges that are engaged to the at least one retention plate by a retention means and an engagement portion selectively coupled to the brace plate and configured to be selectively secured to a wheeled and handled cart or the like.

### BRIEF DESCRIPTION OF THE DRAWINGS

The present invention is illustrated and described herein with reference to the various drawings, in which like reference numbers are used to denote like assembly components, as appropriate, and in which:

FIG. 1 is a perspective view illustrating one exemplary embodiment of the multi-purpose carrier assembly of the present invention;

FIG. 2 is a perspective view of an optional multi-purpose hitch and a carrier assembly, including a number of arrangements of the multi-purpose carrier assembly engaged to an upright safety grab bar illustrating one exemplary embodiment of the multi-purpose hitch and carrier assembly of the present invention to be utilized on a golf cart without seats and/or an upright safety grab bar;

FIG. 3 is an exploded view of the multi-purpose carrier assembly of the present invention;

FIG. 4A is a perspective view of an exemplary embodiment of the engagement portion of the multi-purpose carrier assembly of the present invention engaged with a conventional wheeled and handled utility cart;

FIG. 4B is a perspective view of an exemplary embodiment of the engagement portion of the multi-purpose carrier assembly of the present invention engaged with a conventional wheeled and handled utility cart of a larger diameter than that shown in FIG. 4A;

FIG. 5 is a perspective view of an exemplary embodiment of the multi-purpose hitch assembly receiving an upright safety grab bar;

FIG. 6A is a perspective view of an exemplary embodiment of the multi-purpose hitch assembly with a hinged extension arm in the upright position for receiving an upright safety grab bar;

FIG. 6B is a perspective view of an exemplary embodiment of the multi-purpose hitch assembly with a hinged extension arm in the downward position; and

FIG. 7 is a perspective view of another exemplary embodiment of the carrier assembly engaged to an upright safety grab bar;

FIG. 8 is a perspective view of another exemplary embodiment of the carrier assembly engaged to a golf cart or the like.

FIG. 9 is a perspective view exemplary embodiment of the multi-purpose hitch assembly with a hinged extension arm in the upright position for receiving an upright safety grab bar, including a basket that may be engaged to an embodiment of the multi-purpose carrier assembly.

FIG. 10 is an exemplary embodiment of a basket that may be engaged to an embodiment of the multi-purpose carrier assembly.

FIG. 11 is a perspective view of a another exemplary embodiment of the multi-purpose hitch assembly engaged to an upright safety grab bar and a basket engaged to a retention plate of the multi-purpose hitch assembly.

FIG. 12 is a perspective view of an end that may be disposed on the engagement portion of the carrier assembly.

### DETAILED DESCRIPTION OF THE INVENTION

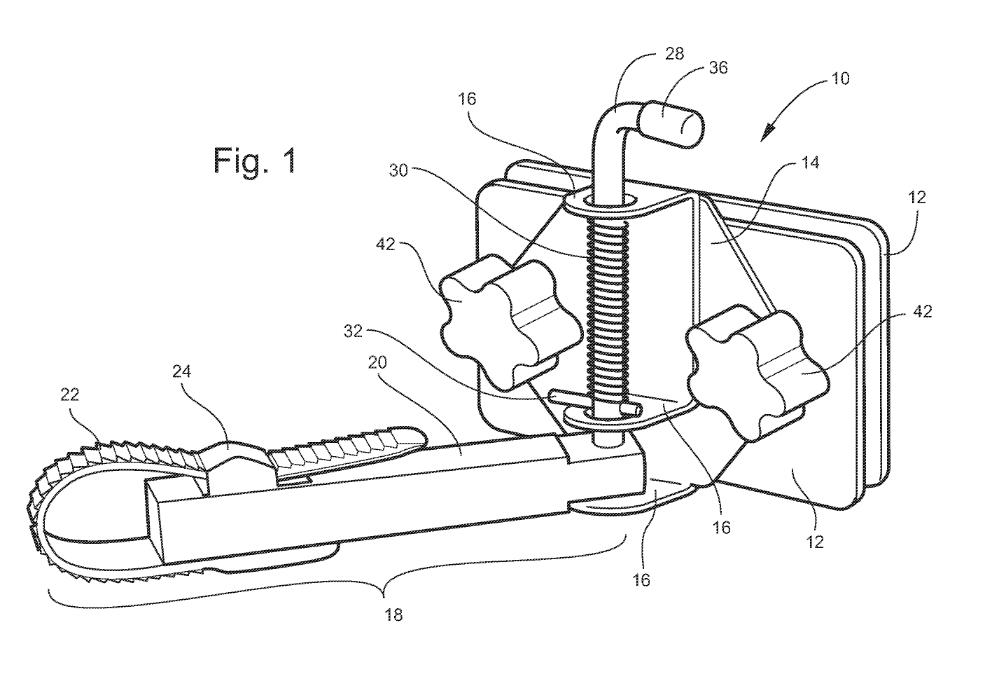

Referring now specifically to the drawings, an exemplary multi-purpose carrier assembly is illustrated in FIG. 1 and is shown generally at reference numeral 10. As illustrated, the multi-purpose carrier assembly 10 has two retention plates 12. A brace plate 14 is engaged to the two retention plates 12. The brace plate 14 includes three flanges 16 extending from the surface of the base plate 14 in a substantially perpendicular direction. An engagement portion 18 is engaged to the brace plate 14 for receiving a wheeled and handled utility cart or the like.

The engagement portion 18 contains a shank 20, a retaining strap 22, and a clip 24. The shank 20 includes a first end and a second end, wherein the first end is tapered, non-tapered, or recessed. The first end of the shank 20 is disposed between two of the flanges 16 positioned on the brace plate 14. The shank 20 is preferably recessed for providing more clearance when the shank 20 is inserted between the flanges 16. The retaining strap 22 is engaged to the second end of the shank 20. The retaining strap 22 has a first end and a second end, whereby the first end is attached to the second end of the shank 20. The second end of the retaining strap 22 may be attached to the second end of the shank 20 by way of an adhesive, a rivet, or the like. It will be appreciated by one of ordinary skill in the art that the second end of the retaining strap 22 may be engaged to the shank 20 utilizing a number of different devices or adhesives.

The first end of the retaining strap 22 is selectively secured to the second end of the shank 20 by way of a clip 24. The clip 24, as illustrated in FIG. 1, is mounted to the shank 20 and has a top that is hingedly connected to a base. When the top of the clip 24 is lifted, the second end of the retaining strap 22 is inserted between the top and the base of the clip 24, forming a semi-circle between the first end and second end of the retaining strap 22. When the top of the clip 24 is in the closed position, meaning the base and top of the clip 24 are an integral unit, the retaining strap 22 is selectively secured within the clip 24. The diameter of the semi-circle formed by the retaining strap 22 may be adjusted depending upon the length of the retaining strap 22 pulled through the clip 24.

The flanges 16 contain a flange bore 26 for receiving a retaining pin 28. As illustrated in FIG. 1, the flanges 16 are arranged in a stacked relationship. In other words, the flanges 16 are aligned one on top of another. The flange bores 26 are also aligned, allowing the retaining pin 28 to be inserted through the flange bores 26. The retaining pin 28 is positioned within the flange bores 26 on the flanges 16. A biasing element 30 is positioned along the outside of the retaining pin 28 and between two of the flanges 16 as illustrated in FIG. 1. A pin 32 is inserted perpendicular to the longitudinal direction of the axis of the retaining pin 28 in a through hole 34. The through hole 34 runs the width of the retaining pin and has a diameter slightly larger than that of the pin 32. The pin 32 serves to retain one end of the biasing element 30, and in return, the biasing element 30 exerts a force upon the pin 32. The other end of the biasing element 30 is adjacent the top flange 16 and exerts a force upon the top flange 16.

In another alternative embodiment, the lowest flange 16 does not contain a flange bore 26, but the lowest flange 16 serves as a base for the shank 20 or retaining pin 28. In this embodiment, the base of the retaining pin 28 is disposed against the third flange 16.

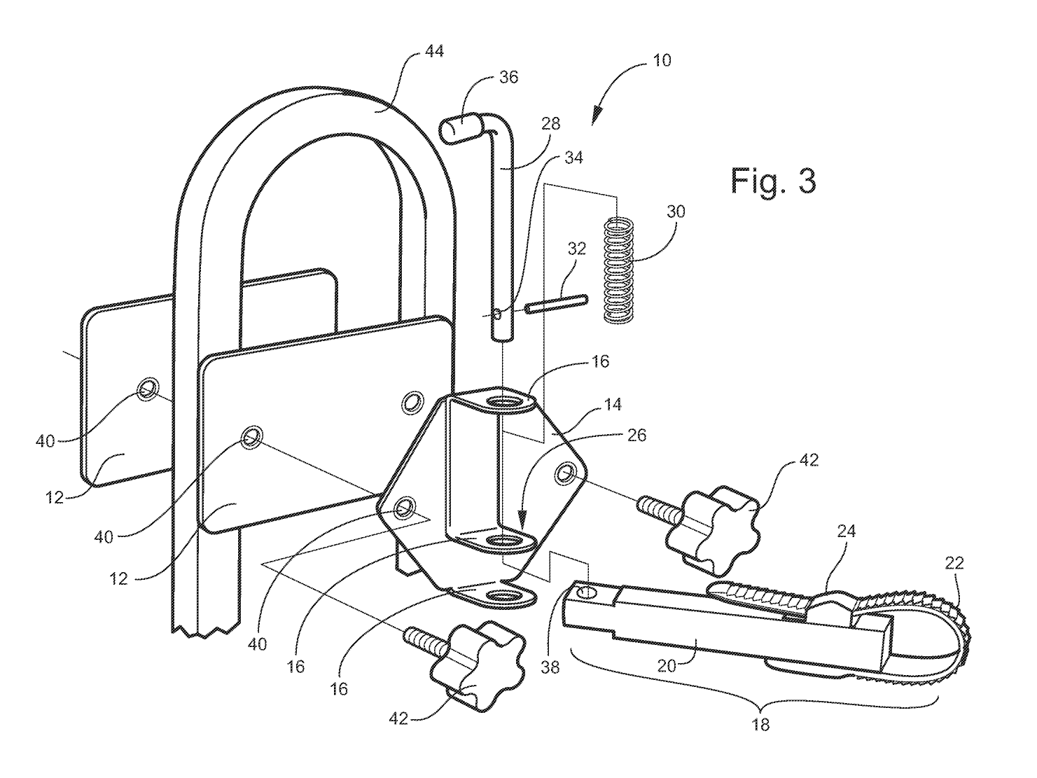

The retaining pin 28 may have a curved upper portion with a cap 36 for allowing a user to easily grip and pull the retaining pin 28 in the upward direction. As the user pulls the retaining pin 28 in the upward direction and overcomes the retention force of the biasing element 30, the retaining pin 28 moves upward, creating a gap between the flange 16 and the retaining pin 28. The shank 20 of the engagement portion 18 is inserted into the gap between the flange 16 and retaining pin 28. As illustrated in FIG. 3, the shank 20 includes a shank bore 38 for receiving the retaining pin 28 and coupling the engagement portion 18 to the brace plate 14. The shank bore 38 extends the width of the shank 20, allowing the retaining pin 28 to extend the full width through the shank 20 and resulting in the retaining pin 28 protruding entirely through the shank bore 38.

A pair of threaded bores 40 are disposed on the brace plate 14 and each retention plate 12. The threaded bores 40 on the brace plate 14 and retention plate 12 are aligned for receiving a retention means 42 and provide for the vertical alignment of the carrier assembly 10 on the upright safety grab bar 44. Preferably, the retention means 42 is correspondingly threaded for insertion into the threaded bores 40 for selectively securing the retention plates 12 to the upright safety grab bar 44. As shown in FIG. 3, a retention plate 12 is positioned on each side of the upright safety grab bar 44, and the retention means 42 is engaged to selectively secure the retention plates 12 to the upright safety grab bar 44 by a friction fit. In a preferred embodiment, the retention means 42 contains a threaded portion that is correspondingly threaded to the threaded bores 40. A handle is disposed onto the threaded portion of the retention means 42 for allowing a user to easily grip the retention means 42 and rotate the retention means 42 for tightening and securing the carrier assembly to the upright safety grab bar.

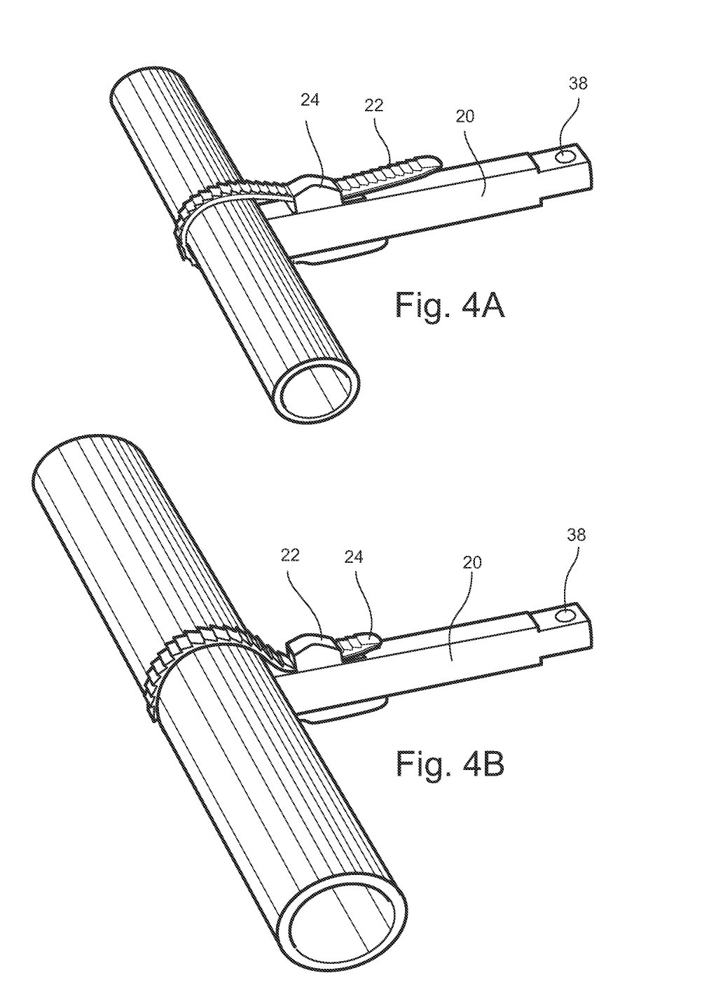

FIGS. 4A and 4B illustrate the retaining strap 22 engaged with a conventional wheeled and handled utility cart. The retaining strap 22 may be adjusted to engage the handle of a conventional wheeled and handled utility cart having various size diameters. As mentioned above, the engagement strap 22 is adjusted by lifting the top of the clip 24 and adjusting the engagement strap 22 within the clip 24, thus adjusting the diameter of the engagement strap 22 my moving the second end with respect to the first end. The engagement strap 22 is resilient, ribbed, and constructed to withstand the potentially large forces the engagement strap 22 may encounter pulling wheeled and handled utility carts and the like.

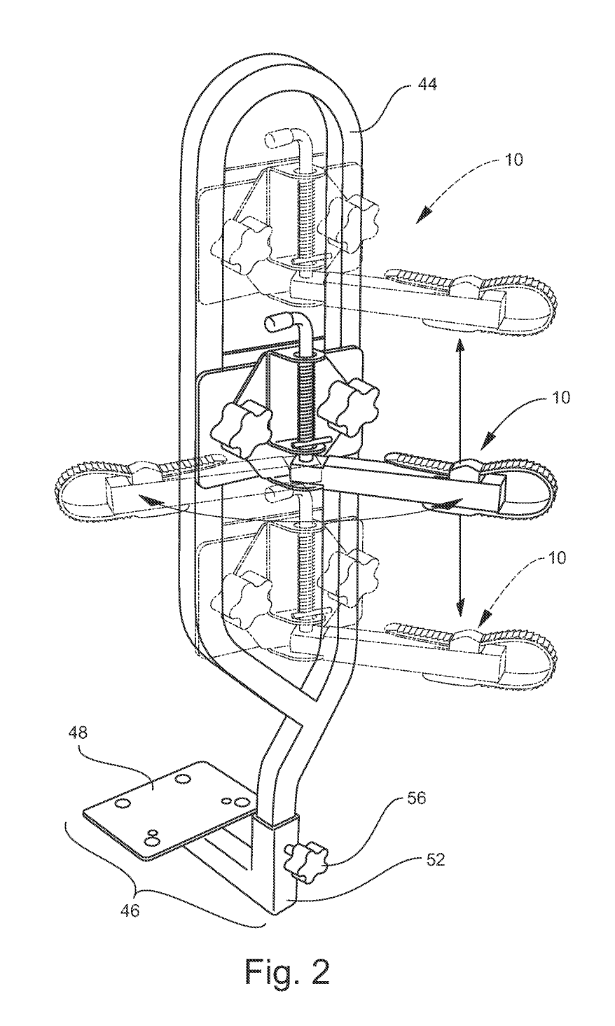

As illustrated in FIG. 2, the multi-purpose carrier assembly 10 may be positioned at any desired location along the length of the upright safety grab bar 44. At any location of the upright safety grab bar 44, the engagement portion 18 is able to rotate about the retaining pin 28. If a golf cart or the like does not have an upright safety grab bar 44, the present invention provides a hitch assembly 46 for engaging an upright safety grab bar 44 to a golf cart or the like. The hitch assembly provides a top plate 48 that may attach to a bolt pattern standard on a majority of bumpers or undercarriages. Alternatively, the top plate 48 may be bolted to the undercarriage of the golf cart or the like, if such a bolt pattern is not available. The top plate 48 has a plurality of bolt holes 50. As illustrated the top plate 48 has four bolt holes 50, including two upper bolt holes 50 and two lower bolt holes 50. Preferably, the top plate 48 is composed of a substantially thick steel plate that is able to withstand the forces exerted by the upright safety grab bar 44 and the act of pulling a wheeled and handled utility cart. However, it should be understood that any size top plate 48 may be utilized and can be composed of any material desired by the user. An extension arm 52 is engaged to the top plate 48 for selectively securing an upright safety grab bar 44 to the golf cart or the like. An embodiment of the extension arm 52 is illustrated in FIG. 2, wherein the extension arm has an elbow that transitions the extension arm 52 about 90 degrees. In other words, a portion of the extension arm 52 is perpendicular to the ground allowing the extension arm 52 to be adjacent the undercarriage of a golf cart or the like, and the extension arm 52 transitions about 90 degrees at an elbow exposing an open end and allowing receipt of an upright safety grab bar 44 that is positioned perpendicular to the ground.

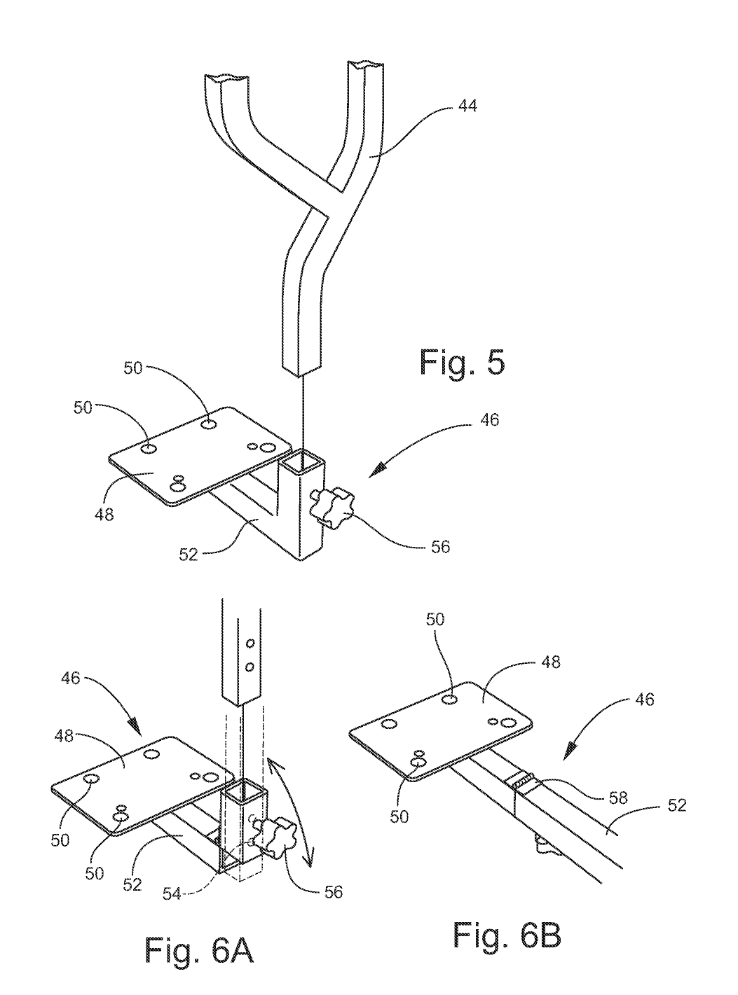

At least one extension arm threaded bore 54 is disposed on the extension arm 52 for receiving a correspondingly threaded upright safety grab bar retention means 56. The upright safety grab bar retention means 56 is much like the retention means described above. The upright safety grab bar retention means 56 contains a threaded shaft and a handle portion for allowing a user to easily rotate the threaded shaft within the correspondingly threaded extension arm threaded bore 54. An upright safety grab bar 44 is inserted into the open end of the extension arm 52, as shown in FIG. 5. Thereafter, the upright safety grab bar retention means 56 is rotated to secure the upright safety grab bar 44 by friction fit. Alternatively, the extension arm 52 may contain more than one extension arm threaded bore 54, allowing the upright safety grab bar 44 to be adjusted in the vertical direction as shown in FIG. 6A.

As illustrated in FIGS. 6A and 6B, the open end of the extension arm 52 is able to translate 90 degrees. The extension arm 52 has a first portion and a second portion, wherein the second portion moves from a first position to a second position. The first position results in the second portion forming a 90 degree angle with respect to the second portion and a second position wherein the second portion is in a linear relationship with the first portion. In one embodiment, the extension includes a hinge 58 on the backside of the elbow of the extension arm 52.

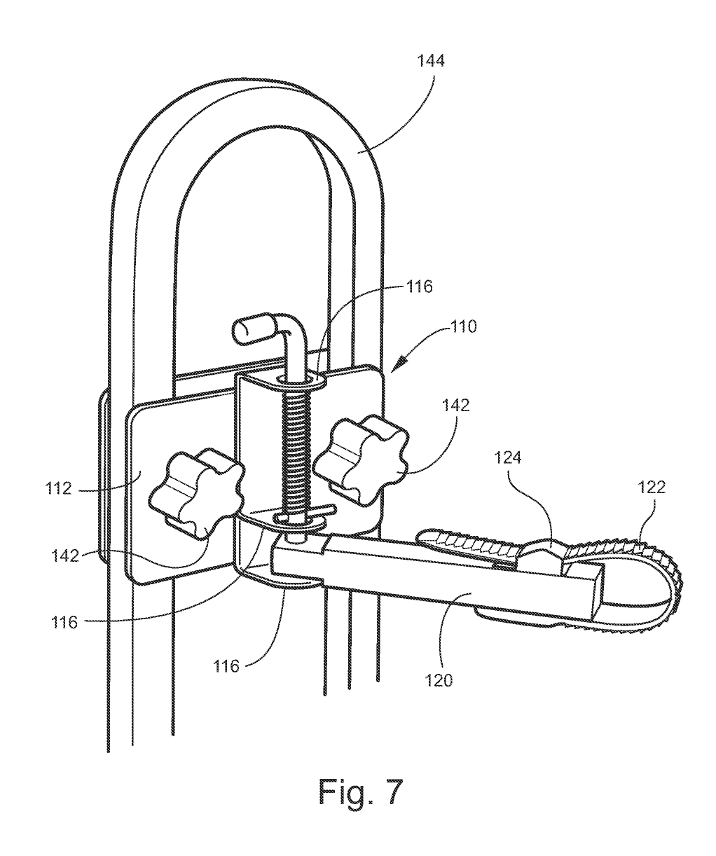

An alternative embodiment of the carrier assembly 110 is illustrated in FIG. 7. The multi-purpose carrier assembly 110 has two retention plates 112 and three flanges 116 extending from the surface of a retention plate 112 in a substantially perpendicular direction. This alternative embodiment also includes a shank 120, a retaining strap 122, and a clip 124. A retention means 142 is provided for tightening the carrier assembly 110 to the upright safety grab bar 144.

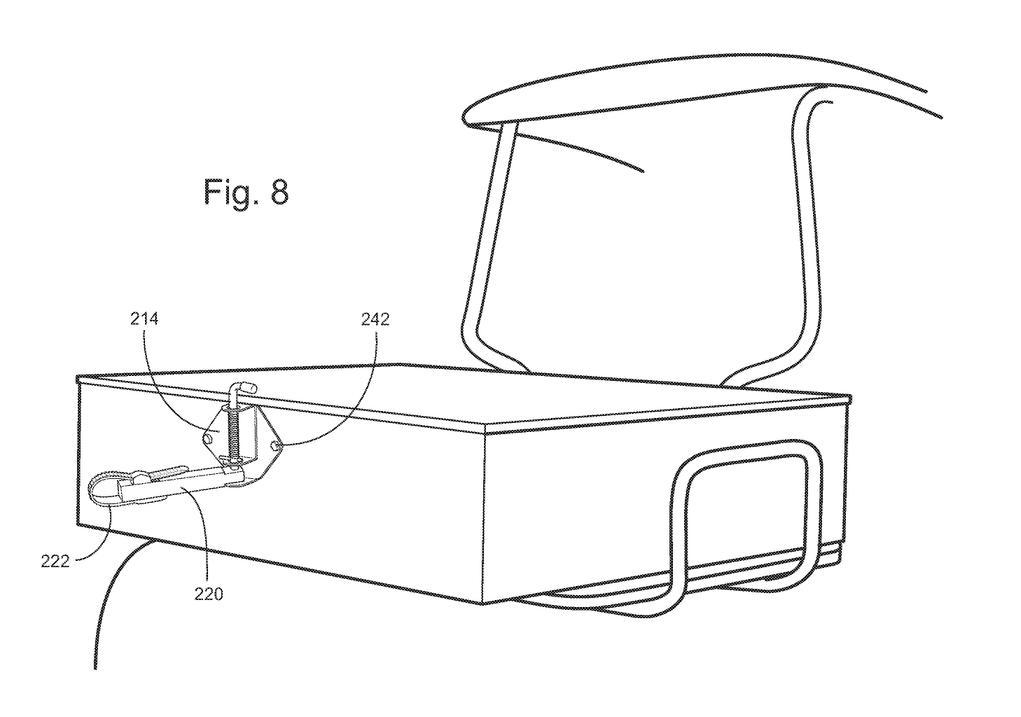

Another alternative embodiment is illustrated in FIG. 8, wherein the retention plate 214 may be engaged to a surface of the golf cart or the like, such as a transport box located on maintenance golf carts. The retention plate 214 is held in place by bolts 242 located on each side of the retention plate 214. A wheeled and handled utility cart may be engaged to the engagement strap 222 that is engaged to a shank 220.

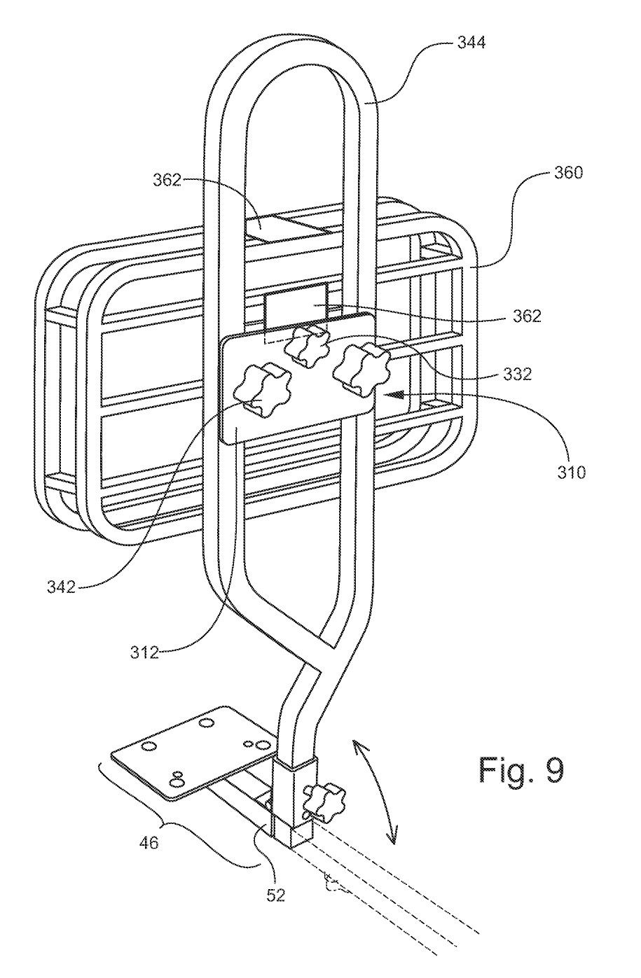

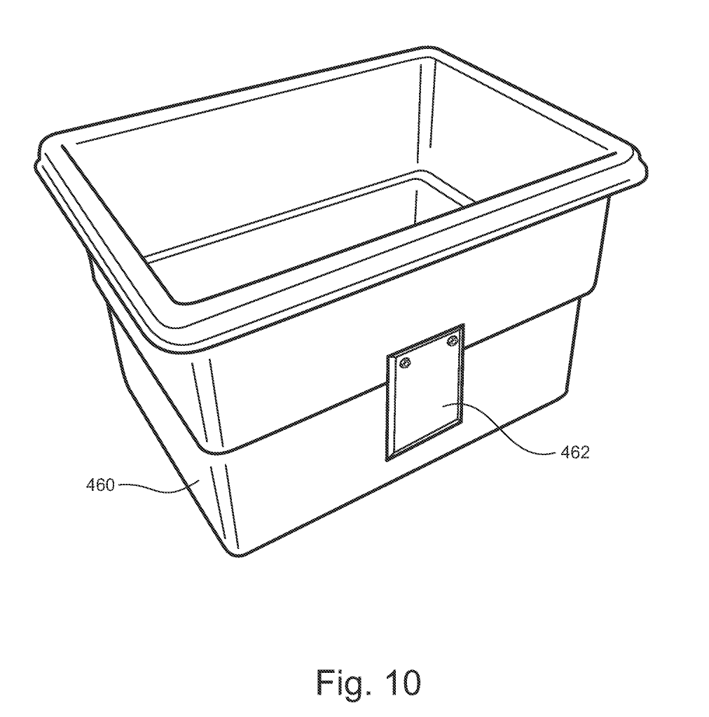

The hinge 58, as illustrated in FIG. 6B, is particularly useful in the embodiment illustrated in FIG. 9. A basket 360 or other similarly useful device for carrying goods and objects may be engaged to the multi-function hitch assembly 46. As illustrated in FIG. 9, a slightly modified multi-function carrier assembly 310 may be employed. The modified carrier assembly 310 includes two retention plates 312 that may be engaged to the upright safety grab bar 344. The retention plates 312 are engaged to the upright safety grab bar 344 by retention means 342. The basket 360 includes a lip 362 that engages a retention plate 312 for selectively securing the basket 360 to the upright safety grab bar 344. A basket retention means 332 is positioned on the retention plate 312 that faces away from the golf cart, and is positioned within a threaded bore (not shown). The basket retention means 332 engages the lip 362 of the basket 360 forming a selectively secured arrangement. The basket 360 is in the stored or upright position as illustrated in FIG. 9. The extension arm 52 may be translated 90 degrees (as indicated by the ghost lines) for the basket 360 to carry items and goods.

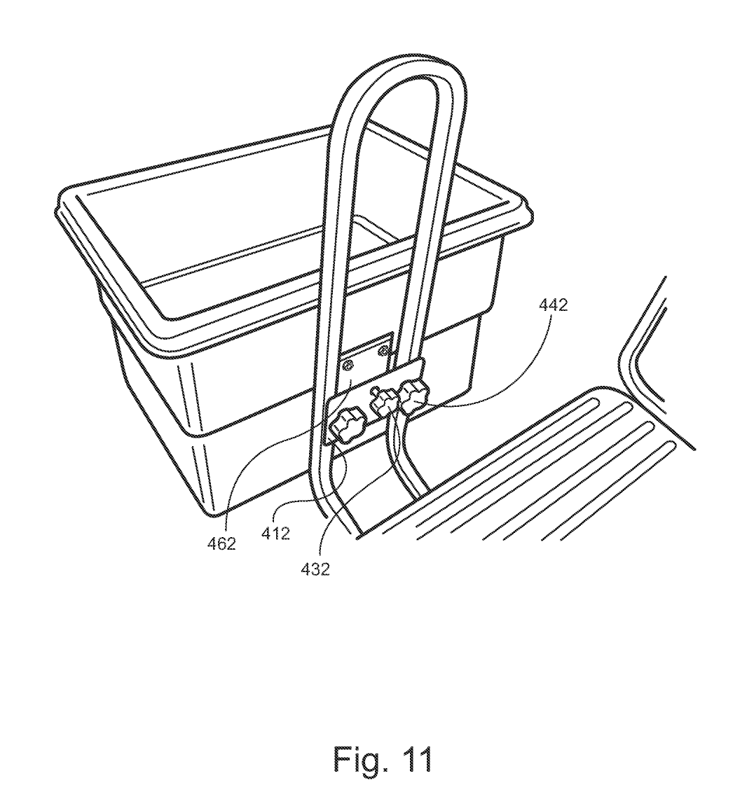

FIGS. 10 and 11 illustrate another exemplary embodiment of the basket 460 that also contains a lip 462 for positioning the basket 460 on a retention plate 412. The basket 460 includes a lip 462 that engages a retention plate 412 for selectively securing the basket 460 to the upright safety grab bar 444. A basket retention means 432 is positioned on the retention plate 412 that faces away from the golf cart, and is positioned within a threaded bore (not shown). The basket retention means 432 engages the lip 462 of the basket 460 forming a selectively secured arrangement. The basket 460 is designed to be carried by a golf cart or the like for transporting objects such as beach bowls, beach umbrellas, golf supplies, and other useful items.

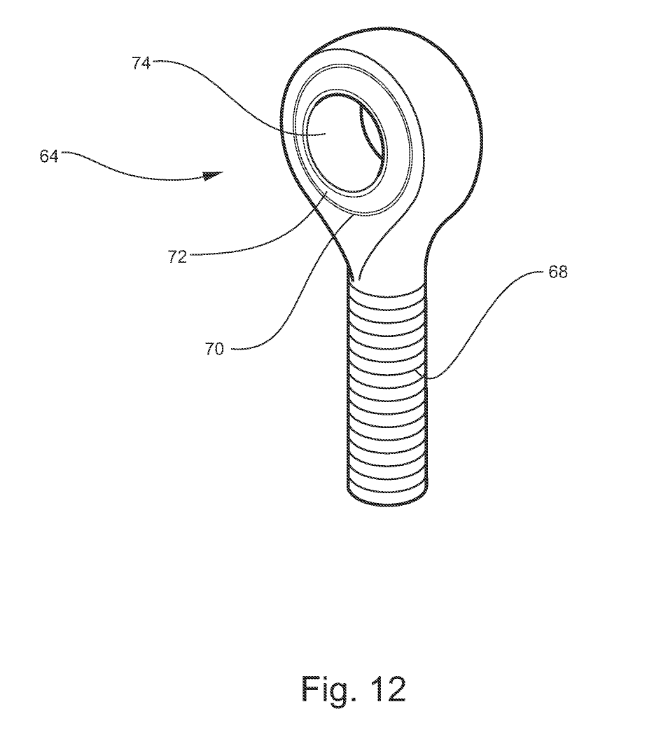

FIG. 12 illustrates an optional end 64 that may be disposed on the first end of the shank 20. The optional end 64 may be positioned between two of the flanges 16 for receiving the retaining pin 32 therethrough. The end 64 contains a threaded portion 68 for selectively securing the end 64 to the first end of the shank 20 by inserting the threaded portion 68 into a correspondingly threaded bore disposed on the first end of the shank 20. The end 64 also contains a bushing 70, and a rotational ball 72 having an eye 74 for receiving the retaining pin 32. The end 64 is commercially available from retailers such as McMaster-Carr®.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, and are contemplated thereby, and are intended to be covered by the following claims.

What is claimed is:

1. A multi-purpose carrier assembly for a golf cart or the like including an upright safety grab bar, comprising:
at least one retention plate configured to be selectively secured to the upright safety grab bar;
at least two flanges; and
an engagement portion selectively coupled to the at least two flanges and configured to be selectively secured to a wheeled and handled utility trailer or the like.

2. The multi-purpose carrier assembly of claim 1, further comprising two retention plates configured to be selectively secured to the upright safety grab bar.

3. The multi-purpose carrier assembly of claim 1, wherein the engagement portion includes a shank and a retaining strap having a first end and a second end, whereby the first end is engaged to the shank and the second end is selectively secured to the shank.

4. The multi-purpose carrier assembly of claim 1, further comprising two retention plates containing a pair of corresponding threaded bores for receiving a correspondingly threaded screw for selectively securing the two retention plates to the upright safety grab bar.

5. The multi-purpose carrier assembly of claim 1, further including a brace plate engaged to the at least one retention member for carrying the at least two flanges.

6. The multi-purpose carrier assembly of claim 1, further including a basket with a lip disposed thereon for selectively securing the basked to a at least one retention plate.

7. A multi-purpose hitch and carrier assembly for a golf cart or the like, comprising:
a top plate assembly, adapted to be carried on a golf cart or the like;
an extension arm engaged to the top plate assembly for selectively securing an upright safety grab bar;
at least one retention plate configured to be selectively secured to the upright safety grab bar;
at least two flanges that are engaged to the at least one retention plate by a retention means; and
an engagement portion selectively coupled to the brace plate and configured to be selectively secured to a wheeled and handled utility trailer or the like.

8. The multi-purpose hitch and carrier assembly of claim 7, wherein the extension arm is hinged, resulting in a first portion and a second portion that moves from a first position to a second position, wherein the first position results in the second portion forming a 90 degree angle with respect to the second portion and a second position wherein the second portion is in a linear relationship with the first portion.

9. The multi-purpose hitch and carrier assembly of claim 7, further comprising two retention plates configured to be selectively secured to the upright safety grab bar.

10. The multi-purpose hitch and carrier assembly of claim 7, wherein the engagement portion includes a shank and a retaining strap having a first end and a second end, whereby the first end is engaged to the shank and the second end is selectively secured to the shank.

11. The multi-purpose hitch and carrier assembly of claim 7, further comprising two retention plates containing a pair of corresponding threaded bores for receiving a correspondingly threaded screw for selectively securing the two retention plates to the upright safety grab bar.

12. The multi-purpose hitch and carrier assembly of claim 7, further comprising a pin that is received within a bore formed within the at least two flanges for selectively coupling the engagement portion to the brace plate.

13. The multi-purpose hitch and carrier assembly of claim 10, wherein the retaining strap is a resilient, ribbed gripping retaining strap.

14. The multi-purpose hitch and carrier assembly of claim 7, further including a basket with a lip disposed thereon for selectively securing the basked to at least one retention plate.

15. A multi-purpose carrier assembly for a golf cart or the like including an upright safety grab bar, comprising:
two retention plates configured to be selectively secured to the upright safety grab bar;
at least two flanges that are engaged to the at least one retention plate by a retention means; and
an engagement portion selectively coupled to the brace plate and configured to be selectively secured to a wheeled and handled utility trailer or the like.

16. The multi-purpose carrier assembly of claim 15, wherein the engagement portion includes a shank and a retaining strap having a first end and a second end, whereby the first end is engaged to the shank and the second end is selectively secured to the shank.

17. The multi-purpose carrier assembly of claim 15, further comprising two retention plates containing a pair of corresponding threaded bores for receiving a correspondingly threaded screw for selectively securing the two retention plates to the upright safety grab bar.

18. The multi-purpose carrier assembly of claim 15, further comprising a pin that is received within a bore formed within the at least two flanges for selectively coupling the engagement portion to the brace plate.

19. The multi-purpose carrier assembly of claim 15, wherein the retaining strap is a resilient, ribbed gripping retaining strap.

20. The multi-purpose carrier assembly of claim 15, further comprising a basket containing a lip, wherein the lip engages a retention plate for carrying the basket on the upright safety grab bar.
